(19) United States
(12) Patent Application Publication
(10) Pub. No.: US 2015/0191196 A1
(43) Pub. Date: Jul. 9, 2015

(54) RACK-AND-PINION STEERING MECHANISM

(71) Applicant: THYSSENKRUPP PRESTA AG, Eschen (LI)

(72) Inventors: Walter König, Wangen (DE); Philippe Steck, Eschen (FI)

(21) Appl. No.: 14/408,875

(22) PCT Filed: Mar. 11, 2013
(86) PCT No.: PCT/EP2013/000712

§ 371 Date: Dec. 17, 2014

(30) Foreign Application Priority Data
Jun. 22, 2012 (DE) 10 2012 012 248.9

(51) Int. Cl. B62D 3/12; F16H 55/28

(52) U.S. Cl. CPC B62D 3/123; F16H 55/286

(57) ABSTRACT

The invention relates to a rack-and-pinion steering system having a pressure piece which pushes a rack against a pinion, a contact face with the rack of the pressure piece being of asymmetrical configuration.

The invention relates to a rack-and-pinion steering system for a motor vehicle in accordance with the precharacterizing clause of independent claim 1.

In rack-and-pinion steering systems, a pressure piece is usually arranged in the region of a rack, which pressure piece is designed in such a way that it presses the rack against a pinion which meshes with the rack. As a result, a play between the rack and pinion and therefore noise produced as a result of play can be avoided. However, noise produced as a result of play cannot be avoided entirely in the known rack-and-pinion steering systems.

It is therefore an object of the present invention to develop the rack-and-pinion steering system mentioned at the outset such that it has a reduced development of noise.

A rack-and-pinion steering system for achieving the object has the features of independent Claim 1. According to said claim, a rack-and-pinion steering system for a motor vehicle is proposed, having a housing, in which a rack is mounted displaceably, a pressure piece being provided in the housing in a bore such that it can be moved slidingly transversely with respect to a longitudinal axis of the rack, the pressure piece being loaded elastically in such a way that it rests with a contact face at least partially on the rack which has a symmetrically configured contact face, and the rack being in engagement at least partially with a pinion on a side which lies opposite the pressure piece, the contact face of the pressure piece being at least partially of asymmetrical configuration. As a result of the asymmetrical design of the contact face of the pressure piece, the rack is not pushed exclusively in the direction of the longitudinal axis of the pressure piece, but rather partially also in the direction of a longitudinal axis of the pinion. As a result, the rack passes into engagement with the pinion in an improved manner over that which has been possible up to now.

According to one preferred refinement of the invention, at least part of the contact face can be configured in such a way that the pressure piece pushes the rack against the pinion in such a way that the longitudinal axis of the rack is arranged with an offset with respect to a longitudinal axis of the pressure piece. The contact face is designed in such a way that the longitudinal axis of the rack is pushed from a theoretical centre by way of the pressure piece, a pressure force of the pressure piece being directed substantially in the direction of the longitudinal axis of the pressure piece. A theoretical centre relates to an intersection of the two longitudinal axes in a relieved state, that is to say when the rack is not loaded with a force by way of the pressure piece.

Furthermore, according to another embodiment, the rack can be pushed against the pinion in such a way that a longitudinal axis of the rack is arranged offset with respect to the longitudinal axis of the pressure piece in the direction of a longitudinal axis of the pinion. As a result of the asymmetry of the pressure piece, the rack is displaced in accordance with the pressure and the structural formation of the components along a longitudinal extent of the pinion.

According to one advantageous development of the invention, the contact face of the pressure piece can have at least two guide faces which are arranged obliquely with respect to one another and correspond substantially with an upper side, preferably two contact faces which are arranged obliquely with respect to one another, of the rack, a first guide face preferably being configured differently to a second guide face.

It can likewise advantageously be provided if the second guide face protrudes at least partially with respect to the first guide face in the direction of the upper side of the rack. As a result of this offset of the two guide faces with regard to the longitudinal axis of the pressure piece, the rack is pushed by the second guide face in the direction of the first guide face and therefore in the longitudinal direction of the pinion.

Further advantageous refinements of the invention are shown in the subclaims.

In the following text, one preferred exemplary embodiment will be explained in greater detail using the drawing, in which:

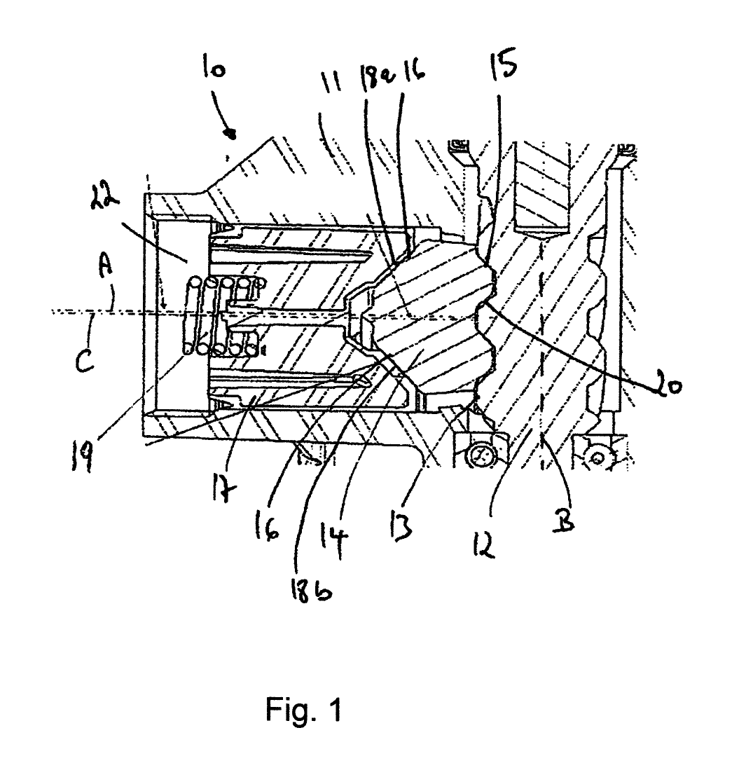

FIG. 1 shows a section through a rack-and-pinion steering system.

FIG. 1 shows a rack-and-pinion steering system 10 having a steering housing 11 in a cross section. A pinion shaft or pinion 12 is mounted rotatably in the steering housing 11. The pinion shaft 12 meshes in the region of a toothing system 13 with a rack 14, and the rack 14 is mounted in the steering housing 11 such that it can be displaced in the direction of a longitudinal axis which lies perpendicularly on the plane of the drawing. Moreover, the longitudinal axis of the rack 14 intersects with a transverse axis A (shown in FIG. 1) of the rack 14, which transverse axis A is arranged centrally in the rack 14. It is suitable for further descriptive purposes to describe the position of the individual components in relation to the axes. In addition to the longitudinal axis of the rack 14, a rotational axis B of the steering pinion 12 is shown, which rotational axis B runs in the plane of the drawing. A longitudinal axis C of a pressure piece likewise runs in the plane of the drawing, the longitudinal axis C running perpendicularly with respect to the rotational axis B and with respect to the longitudinal axis of the rack 14 and parallel to the transverse axis A of the rack 14.

In the region which is shown, the rack 14 is provided with a tooth segment 15 which is formed in a known way on that side of the rack 14 which faces the steering pinion 12. The tooth segment 15 represents an approximately planar surface. Starting from the tooth segment 15, the rack 14 is provided in the direction of its circumference with two guide faces 16 which are inclined at an acute angle with respect to one another and run towards one another in the manner of a trapezium in a manner which adjoins the tooth segment 15. Those ends of the guide faces 16 which face away from the tooth segment 15 are preferably connected to one another via an arcuate circumferential region. Said circumferential region can also have any desired other contour. The cross-sectional design of the rack 14 in this region corresponds approximately to an equilateral trapezium, in which the parallel sides have been rounded and have been provided with the tooth segment 15 on one side. A notional point of intersection of the two symmetrically arranged guide faces 16 which is arranged above the circumferential region intersects with the transverse axis C.

Furthermore, a pressure piece 17 which is arranged in a manner known per se is provided in the steering housing 11, which pressure piece 17 is in contact with the rack 14 via guide faces 18. A recess which has an opening in the region of the rack 14 is provided in the steering housing 11 for the pressure piece 17. The pressure piece 17 is mounted resiliently by means of a spring 19 on a side which lies opposite the rack 14, the pressure piece 17 being pushed against the rack 14 as a result. As a result of the pressure on the rack 14, the latter is pushed against the pinion 12, as a result of which noise can be avoided during the operation of the rack-and-pinion steering system 10. The guide faces 18 of the pressure piece 17 correspond substantially to the guide faces 16 of the rack, a second guide face 18b being slightly elevated with respect to a first guide face 18a.

The guide faces 18 are arranged such that they are inclined with respect to one another by the same angle as the guide faces 16 of the rack 14. As a result of the elevation of the second guide face 18b, however, a notional point of intersection is offset with respect to the longitudinal axis C of the pressure piece 17, for which reason the pressure piece 17 is of asymmetrical configuration in the region of the guide faces 18.

As a result of the elevation of the second guide face 18b, in the case of the force which is directed in the longitudinal direction of the pressure piece 17, the rack 14 is pushed not only against the pinion shaft 12 in the longitudinal direction of the pressure piece 17, but rather also slightly to the side as a result of the oblique contact face between the rack 14 and the pressure piece 17. Sliding occurs in the region of the second guide face 18b and the corresponding guide face 16 of the rack 14, in the case of which sliding the rack 14 is pushed in the direction of the first guide face 18a and at the same time in the axial direction of the pressure piece 17. The elevation therefore produces a relative displacement of the rack 14 with regard to the pressure piece 17, since the pressure piece 17 is guided in the recess in a merely longitudinally displaceable manner and the rack 14 can be moved not only in its longitudinal extent, but rather also laterally.

As a result of the lateral movement of the rack 14, corresponding tooth flanks 20 are held without play by the tooth segment 15 and the toothing system 13 of the pinion shaft 12, since the rack 14 is tensed with respect to the pinion shaft 12 at least in the longitudinal direction of the pinion 12.

According to one exemplary embodiment of the invention, the elevation in the region of the second guide face 18b is achieved by way of an attachment 21, as shown in FIG. 1, which is placed onto the pressure piece 17 and is connected to the latter. The attachment 21 is to be selected with a different size depending on the size and contour of the individual components. The attachment 21 can also be configured, for example, as a template, in which it not only covers the second guide face 18b, but rather also the first guide face 18a, in order that the attachment 21 is held on the pressure piece 17 in an improved manner. A lower region of the pressure piece 17 (in the region of the contact face) can likewise be covered at least partially by the attachment 21, the region of the attachment 21 which covers the second guide face 18b being of thicker configuration than the remaining regions of the attachment 21 in the further examples which are mentioned in the preceding text.

The attachment 21 is connected to the pressure piece 17, the attachment being connected to the pressure piece 17 in a positively locking and/or non-positive manner or else in an integrally joined manner. Here, the attachment 21 can either be adhesively bonded, welded, soldered or clamped. However, it is also possible, for example, to merely position the attachment between the pressure piece 17 and the rack 14, the attachment 21 then being held between the two components as a result of the pressure of the pressure piece 17 on the rack 14.

The pressure piece 17 which is described in the preceding text with an elevation of one of the guide faces 18 can also be arranged subsequently in a rack-and-pinion steering system. Subsequently means in this case that a pressure piece 17 of this type can also be installed into rack-and-pinion steering systems 10 which already exist. Rack-and-pinion steering systems 10 having a pressure piece 17 have an outwardly directed opening in the housing 11 in a manner known per se. An old pressure piece can be removed and can be replaced by the new pressure piece 17 which is described in the preceding text through the opening which is kept closed by way of a cover 22.

1.-6. (canceled)

7. A rack-and-pinion steering system for a motor vehicle, comprising:
a housing;
a rack displaceably mounted in said housing, having a longitudinal axis, an upper side having a symmetrically configured contact face defined thereon, and a lower side opposite said upper side;
a pressure piece disposed in a bore in said housing adjacent to said upper side of said rack and having an at least partially asymmetrical contact face defined thereon, said pressure piece being elastically biased toward said rack such that said asymmetrical contact face is forced into contact with said symmetrical contact face on said upper side of said rack, said pressure piece further configured to be slidingly moveable in a transverse direction with respect to the longitudinal axis of said rack; and
a pinion mounted in said housing and engaged with said rack on said lower side thereof.

8. The rack-and-pinion steering system of claim 7, wherein said asymmetrical contact face of said pressure piece forces said rack against said pinion such that said longitudinal axis of said rack is offset from said longitudinal axis of said pressure piece.

9. The rack-and-pinion steering system of claim 7, wherein said rack is forced against said pinion such that the longitudinal axis of said rack is offset with respect to said longitudinal axis of said pressure piece in a direction of a longitudinal axis of said pinion.

10. The rack-and-pinion steering system of claim 7, wherein said contact face of said pressure piece has at least first guide face and a second guide face that are obliquely arranged with respect to each other and configured to be placed in contact with two complimentary obliquely arranged contact faces on said upper side of said rack, wherein said first guide face of said pressure piece is asymmetric relative to said second guide face about said longitudinal axis of said pressure piece.

11. The rack-and-pinion steering system of claim 10, wherein said second guide face of said pressure piece at least partially protrudes with respect to said first guide face in a direction of said upper side of said rack.

12. The rack-and-pinion steering system of claim 10, wherein said second guide face of said pressure piece has an elevation with respect to said first guide face such that a line of intersection of said first and second guide faces is offset with respect to said longitudinal axis of said pressure piece.
